(19) United States
(12) Patent Application Publication
(10) Pub. No.: US 2014/0267601 A1
(43) Pub. Date: Sep. 18, 2014

(54) SYSTEM AND METHOD FOR EFFICIENT EDITING OF 3D VIDEO

(71) Applicant: COREL CORPORATION, Ottawa (CA)

(72) Inventors: Dieter Huber, Deisenhofen (DE); Andreas E. Pick, Munich (DE)

(73) Assignee: Corel Corporation, Ottawa (CA)

(21) Appl. No.: 13/827,704

(22) Filed: Mar. 14, 2013

(51) Int. Cl. H04N 13/00

(52) U.S. Cl. CPC H04N 13/0007
USPC 348/43

(57) ABSTRACT

A method includes the steps of: providing a computer readable non-transitory storage medium including a computer readable code configured to run on a computer and configured to perform a process to edit a stereoscopic 3D video on a 2D computer screen by use of a 2D editing application user interface (UI); processing a left eye video pipeline and a right eye video pipeline according to controls of the 2D editing application UI; and displaying simultaneously both of the stereoscopic 3D video in stereoscopic 3D and the 2D editing application user interface (UI) in 2D on a common 2D display. A system to perform the method is also described.

### FIELD OF THE INVENTION

The invention relates to video editing and more particularly to editing of 3D video.

### BACKGROUND OF THE INVENTION

According to the prior art, editing of 3D video has generally been accomplished by working in a video editing program through a conventional display screen. Another application and/or other display screen is generally used to view the edited 3D video with 3D viewing glasses appropriate to the 3D encoding scheme. At best, a user editing a 3D video must constantly shift their vision and/or head to another computer display to see a 3D rendering of their most recent edits.

### SUMMARY OF THE INVENTION

According to one aspect, the invention features a method which includes the steps of: providing a computer readable non-transitory storage medium including a computer readable code configured to run on a computer and configured to perform a process to edit a stereoscopic 3D video on a computer screen by use of a 2D editing application user interface (UI); processing a left eye video pipeline and a right eye video pipeline according to controls of the 2D editing application UI; and displaying simultaneously both of the stereoscopic 3D video in stereoscopic 3D and the 2D editing application user interface (UI) in 2D on a common display.

In one embodiment, the stereoscopic 3D video includes a true color stereoscopic 3D content.

In another embodiment, the stereoscopic 3D video includes a portion of a displayed window.

In yet another embodiment, the stereoscopic 3D video includes a pop-up window.

In yet another embodiment, the stereoscopic 3D video includes a dialog window.

In yet another embodiment, the step of displaying simultaneously includes the step of displaying simultaneously a stereoscopic 3D display of a combination of a processed left eye video pipeline and a processed right eye video pipeline and the 2D application UI on the common display while manipulating a stereoscopic video stream of the stereoscopic 3D video by one or more editing operations performed in the 2D UI.

In yet another embodiment, the method further includes the step of adding video effects to the stereoscopic 3D video.

In yet another embodiment, the method further includes the step of viewing the video effects in the stereoscopic 3D video on the common display.

In yet another embodiment, a user's left eye sees the 2D application UI and a left eye stream of the stereoscopic 3D video.

In yet another embodiment, a user's right eye sees the 2D application UI and a right eye stream of the stereoscopic 3D video.

In yet another embodiment, the process is configured to allow a user to switch smoothly between modes selected from the group of modes consisting of left eye only, right eye only, side-by-side, top-bottom, differential, anaglyph, and checkerboard.

In yet another embodiment, the 2D application UI further includes a video timeline.

According to another aspect, the invention features a system which includes a computer configured to run a computer readable code configured to perform a process to edit a stereoscopic 3D video on a computer screen by use of a 2D editing application user interface (UI). Stereoscopic glasses are communicatively coupled to the computer. A computer display is also coupled to the computer. The computer readable code is configured to display simultaneously both of the stereoscopic 3D video in stereoscopic 3D and the 2D editing application user interface (UI) in 2D on a common display.

In one embodiment, the stereoscopic glasses include shutter glasses.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows one exemplary computer display screen according to the process described herein;

FIG. 2 shows a block diagram of an exemplary stereoscopic video processing pipeline;

FIG. 3 shows a block diagram of an exemplary application display composition;

FIG. 4 shows an exemplary diagram of what the human eyes see when a user views the display screen of FIG. 1;

FIG. 5 shows an exemplary screen print of an display generated by a 3D video editing program according to the diagram of FIG. 4;

FIG. 6 shows a more detailed block diagram of a software architecture to combine the 2D video editing program display with the stereoscopic 3D video being edited;

FIG. 7 shows a block diagram of a system suitable for performing the processes described herein; and

FIG. 8 shows a table of exemplary LCD monitors suitable for use in the processes described herein.

### DETAILED DESCRIPTION

There is a need for a more efficient system and method for editing 3D video.

A solution is a system and method which allows for a 3D rendering of the 3D video being edited in a 2D application on one common 3D capable computer display screen. It was realized that a user editor can view through any suitable glasses both a 2D representation typically used for 3D editing as well as a window on the same screen presenting the edited 3D video in a 3D rendering. The combined displays on one screen allow for more efficient editing of 3D video, because the effect of successive edits can be substantially viewed immediately as the edits are performed.

A system and method as an application to manipulate stereoscopic 3D videos on a single computer screen while showing the videos in stereoscopic 3D and the application in 2D is now described. In one embodiment, the system includes a computer system capable of displaying true color stereoscopic 3D content by providing different views for the left and right eyes and software for streaming, editing and manipulating stereoscopic 3D videos.

FIG. 1 shows one exemplary embodiment of a computer display 100. One portion of the screen can be used to display the control part of the application. Another portion of the screen can be dedicated to display the stereoscopic 3D video 101 in true color by means of the provided computer system. The exemplary screen layout of FIG. 1 includes clip browser area 102, effect and arrangement area 103, control bar 104, including controls such as for example a display mode selector 105.

The stereoscopic video stream can be accomplished by timely arranging and adding effects. The applied effects can be viewed on the stereoscopic video stream 101. By technical means of the computer system the left eye sees the 2D part of the application and the left eye stream of the stereoscopic 3D video. The right eye similarly sees the 2D part of the application and the right eye stream of the stereoscopic 3D video. The size of the 3D video display area 101 can be freely adjustable and/or re-sizeable. The number of 3D video display areas is not limited to a single view. The application can allow a user to switch smoothly to different 2D based view modes (e.g. left eye only, right eye only, side-by-side, top-bottom, differential, anaglyph, checker board). The 3D video display area need not be bound to the main window, for example, a 3D video display can be implemented as a dialog or pop-up window.

FIG. 2 shows a block diagram of an exemplary stereoscopic video processing pipeline. Video information for the left eye 201a is processed by effect processing 202a. Video information for the right eye 201b is processed by effect processing 202b. The processed information from both the left eye stream and the right eye stream are combined into an eye composition 203 pipeline for 3D video display context 204.

FIG. 3 shows a block diagram of an exemplary application display composition. The 3D video display context (e.g. from a 3D video display context 204) is combined with a 2D application display context pipeline by combiner 303. The output video from combiner 330 is the combined display context 304 which can be displayed on a computer display screen.

FIG. 4 shows an exemplary diagram of what the human eyes see when a user views the display screen of FIG. 1, where the video has been processed according to the steps of FIG. 2 and FIG. 3.

FIG. 5 shows an exemplary screen print of a display generated by a 3D video editing program according to the diagram of FIG. 4. While it is not possible show a “live” 3D rendering in a black and white patent illustration, those skilled in the art will recognize that the water wheel shown on the upper right side of the screen as the stereoscopic 3D video 101 of FIG. 1.

Example: FIG. 6 shows a more detailed block diagram of a software architecture to combine the 2D video editing program display with the stereoscopic 3D video being edited. The example uses the RTFx video effects processing Engine™ and the Nemo engine video to texture Renderer™, both available from the NVIDIA corporation of Santa Clara, Calif. Direct X™ is used to yield left and right images and a NVIDIA 3D context Driver™ was used to provide the 3D context for the stereoscopic 3D video display portion of the computer display screen. Simultaneously, a main application window program used the Windows™ Presentation Foundation™ available from Microsoft Corporation of Redmond, Wash. coupled into application frames and 2D context driver to create a 2D display in the clip browser area.

FIG. 7 shows a block diagram of a system suitable for performing the processes described herein. Any suitable computer includes any suitable operating system, a video editing application, and driver for a graphics display board having stereoscopic display capability. Any suitable display having a stereoscopic display capability can be coupled to the graphics display card by any suitable video connection, typically a video display cable (DVI, RGB, etc.). Further, the computer includes any suitable communication link where dynamic stereo glasses are used (e.g. 3D shutter glasses), such as an IR link.

### Example

A system to perform the processes described herein was configured with an Intel™ HP Pavillion Elite™ personal computer (PC), Windows 7™ or Windows 8™ operating system, an nVidea 3D™ vision starter kit as the 3D shutter glasses and IR controller. An nVidia GTX series card was used as the 3D graphics card. FIG. 8 shows a table of exemplary LCD monitors which have a stereoscopic display capability (e.g. 3D capable monitors) suitable for use in the processes described herein. A suitable computer display to perform the processes described herein is understood to have 3D display capability.

A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a computer and configured to perform a process to edit a stereoscopic 3D video on a computer screen by use of a 2D editing application user interface (UI);
processing a left eye video pipeline and a right eye video pipeline according to controls of said 2D editing application UI; and
displaying simultaneously both of said stereoscopic 3D video in stereoscopic 3D and said 2D editing application user interface (UI) in 2D on a common display.

2. The method of claim 1, wherein said stereoscopic 3D video comprises a true color stereoscopic 3D content.

3. The method of claim 1, wherein said stereoscopic 3D video comprises a portion of a displayed window.

4. The method of claim 1, wherein said stereoscopic 3D video comprises a pop-up window.

5. The method of claim 1, wherein said stereoscopic 3D video comprises a dialog window.

6. The method of claim 1, wherein said step of displaying simultaneously comprises the step of displaying simultaneously a stereoscopic 3D display of a combination of a processed left eye video pipeline and a processed right eye video pipeline and said 2D editing application UI on said common display while manipulating a stereoscopic video stream of said stereoscopic 3D video by one or more editing operations performed in said 2D editing application UI.

7. The method of claim 6, further comprising the step of adding video effects to said stereoscopic 3D video.

8. The method of claim 7, further comprising the step of viewing said video effects in said stereoscopic 3D video on said common display.

9. The method of claim 1, wherein a user's left eye sees the 2D editing application UI and a left eye stream of said stereoscopic 3D video.

10. The method of claim 1, wherein a user's right eye sees the 2D editing application UI and a right eye stream of said stereoscopic 3D video.

11. The method of claim 1, wherein said process is configured to allow a user to switch smoothly between modes selected from the group of modes consisting of left eye only, right eye only, side-by-side, top-bottom, differential, anaglyph, and checkerboard.

12. The method of claim 1, wherein said 2D editing application UI further includes a video timeline.

13. A system comprising:
a computer configured to run a computer readable code configured to perform a process to edit a stereoscopic 3D video on a computer screen by use of a 2D editing application user interface (UI);
stereoscopic glasses communicatively coupled to said computer;
a computer display coupled to said computer; and
wherein said computer readable code is configured to display simultaneously both of said stereoscopic 3D video in stereoscopic 3D and said 2D editing application user interface (UI) in 2D on said display.

14. The system of claim 13, wherein said stereoscopic glasses comprise shutter glasses.
